(19) United States
(12) Patent Application Publication
(10) Pub. No.: US 2008/0313708 A1
(43) Pub. Date: Dec. 18, 2008

(54) Data content matching

(75) Inventors: Faud Ahmad Khan, Osgoode (CA); Kevin McNamee, Ottawa (CA)

Correspondence Address: KRAMER & AMADO, P.C., 1725 DUKE STREET, SUITE 240, ALEXANDRIA, VA, 22314, US

(73) Assignee: ALCATEL LUCENT, Paris (FR)

(21) Appl. No.: 11/808,604

(22) Filed: Jun. 12, 2007

(51) Int. Cl. H04L 9/32

(52) U.S. Cl. 726/3

(57) ABSTRACT

A method, device and system for matching data content, including identifying items of data that would be potentially harmful if transferred through a network, creating a list containing the identified items of potentially harmful data, deriving a hash value for each item of data on the list, receiving a data stream containing data packets, calculating a hash value for each data packet in the data stream, evaluating whether any of the hash values calculated for the data packets in the data stream match any of the hash values derived for each item of data on the list, discovering a hash value match between one of the data packets in the data stream and one of the items of data on the list, comparing the actual contents of the one data packet in the data stream to the actual contents of the one item of data on the list, confirming a match between the actual contents of the one data packet in the data stream and the one item of data on the list, and applying a filter policy that restricts a further transfer of the one data packet through the network. Some embodiments also include identifying a field of interest for each item of data on the list and for each data packet in the data stream.

### BACKGROUND OF THE INVENTION

1. Field of the Invention

This invention relates generally to systems and methods for matching data content in data transferred through a network.

2. Description of Related Art

Deep packet inspection (DPI) is a form of computer network packet filtering that examines the data part of a through-passing packet, searching for non-protocol compliance or predefined criteria to decide if the packet can pass. An intrusion prevention system (IPS) is a computer security device that exercises access control to protect computers from exploitation. IPS technology is considered by some to be an extension of intrusion detection technology but it is actually another form of access control, like an application layer firewall. The latest next generation firewalls leverage their existing DPI engine by sharing this functionality with an IPS. In connection with the foregoing, there is a need for systems and methods for matching data content in data transferred through a network.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

In light of the present need for systems and method for matching data content, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

Various exemplary embodiments are a method, device or system for matching data content, including identifying items of data that would be potentially harmful if transferred through a network, creating a list containing the identified items of potentially harmful data, deriving a hash value for each item of data on the list, receiving a data stream containing data packets, calculating a hash value for each data packet in the data stream, evaluating whether any of the hash values calculated for the data packets in the data stream match any of the hash values derived for each item of data on the list, discovering a hash value match between one of the data packets in the data stream and one of the items of data on the list, comparing the actual contents of the one data packet in the data stream to the actual contents of the one item of data on the list, confirming a match between the actual contents of the one data packet in the data stream and the one item of data on the list, and applying a filter policy that restricts a further transfer of the one data packet through the network. Some embodiments also include identifying a field of interest for each item of data on the list and for each data packet in the data stream.

### BRIEF DESCRIPTION OF THE DRAWINGS

In order to better understand various exemplary embodiments, reference is made to the accompanying drawings, wherein:

FIG. 1 is a flowchart of an exemplary embodiment of a method of data content matching;

FIG. 2 is a schematic diagram of an exemplary embodiment of a system for data content matching; and

FIG. 3 is a schematic diagram of an embodiment of data as used in a system and method for data content matching.

### DETAILED DESCRIPTION OF THE PREFERRED EMBODIMENTS OF THE INVENTION

Increasingly, additional requirements are being placed on carriers and enterprise networks to be able to scan the content of data packets transferred in the networks at the full bandwidth of every communication channel used in the network, that is, at line rates. Some such approaches use logic trees and different types of N-gram algorithms.

High speed networks, including networks capable of operating at a data transfer rate of ten gigabytes and above, are becoming more prevalent. It is believed to be extremely difficult, perhaps even impossible, for such high speed networks to inspect every single data packet transferred through the network. Further, known approaches for inspecting data packets transferred through networks are time consuming.

Thus, there is a need for a method and system capable of inspecting data packets transferred in a network that is less time consuming than previously used approaches. Specifically, there is a need for performance and efficiency when inspecting and processing large volumes of packets for malicious content in DPI and IPS in carrier and enterprise networks.

It is believed to be important that IPS and DPI systems are able to efficiently scan data packets transferred through carrier and enterprise networks for an extremely large number of attack signatures that indicate the presence of malicious data traffic across the network. Some approaches attempt to match specific character strings or binary sequences within specific data packets to a set of known specific character strings or binary sequences representative of malicious data packets. Many different approaches are employed in performing this function in various exemplary embodiments.

However, some approaches put a significant load on the packet processing resources of the device and system. This results in a latency responsible for an unacceptable reduction in data transfer rates. Sometimes, the loss of data packets even occurs due to the load placed on the packet processing resources of the device and system.

The resources used by a system to inspect data packets for malicious content include processing power of the system, memory in the system, and specialized hardware in the system that is used for pattern recognition of malicious data packets. The subject matter described below, includes a system and method for data packet analysis that is able to maintain and sustain a high rate of efficiency in evaluating and processing large volumes of data packets for malicious content.

Specifically, various exemplary embodiments are systems and methods that efficiently match character strings or binary sequences from transferred data packets to a set of known attack signatures. This approach is believed to be significantly more efficient than other methods and systems for matching data content. Thus, the processing requirements on the system in order to evaluate the presence of a signature matching malicious data packets is significantly reduced by the subject matter described below. In turn, this significantly improves the performance of the device and system by reducing latency time and packet loss.

The subject matter described herein is believed to be useful any time a pattern to be matched is known to be present in the specific field within a data packet.

Referring now to the drawings, in which like numerals refer to like components or steps, there are disclosed broad aspects of various exemplary embodiments.

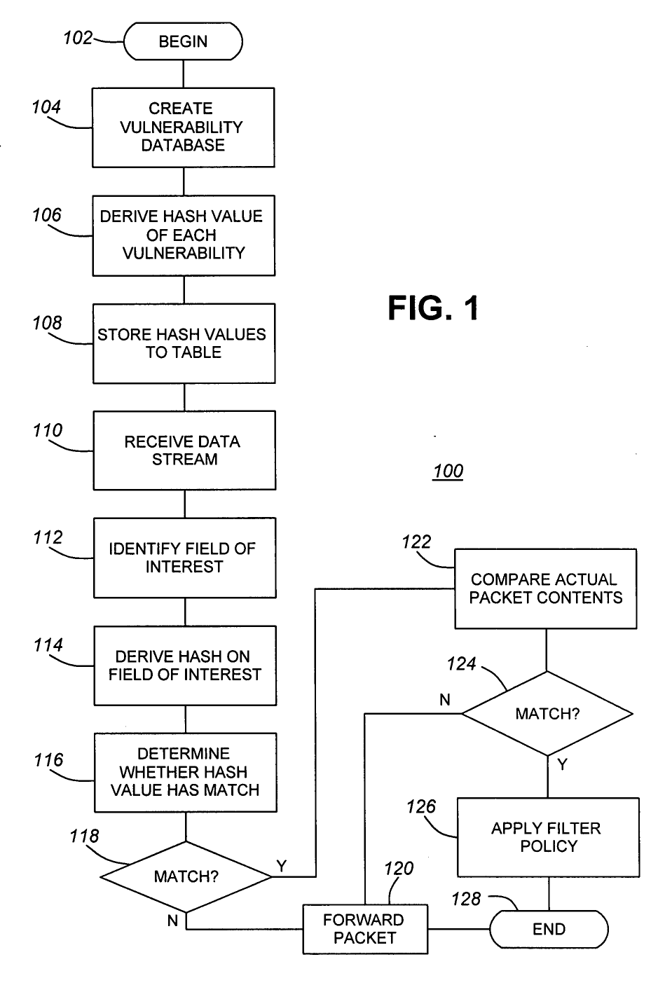

FIG. 1 is a flowchart of an exemplary embodiment of a method 100 of data content matching. The method 100 begins in step 102 and then continues to step 104. In step 104, a vulnerability database is created. The vulnerability database is a database of all known types of data packets believed to be malicious or otherwise creating vulnerabilities in the system when transferred through the network.

Following step 104, the method 100 proceeds to step 106 where a hash value is derived for each vulnerability listed in the database created in step 104. The purpose of deriving hash values for each vulnerability created in the vulnerability database in step 104 is to dramatically increase the speed at which data packets being transferred through the network can be evaluated for a match with each vulnerability in the database. The hash can be developed according to any known algorithm.

In calculating the hash value in step 106, various exemplary embodiments locate a field of interest in a data packet. It should be noted that the field of interest could be a uniform resource locater (URL) in the case of data packets that correspond to Internet websites. Thus, in various embodiments, the hash value is calculated based on the field of interest located in the data packet in step 106.

On the foregoing basis, various exemplary embodiments of the method 100 are implemented in an IPS device. Similarly, various exemplary embodiments are implemented in a DPI device. Likewise, other devices are known, or may later be developed, that rely on matching character patterns or binary patterns. Any such technique can be implemented in various exemplary embodiments.

In various embodiments, packets are processed on a first in first out (FIFO) manner. In other exemplary embodiments, packets are processed on a last in first out (LIFO) basis. It should be apparent that other regimes for determining the order in which packets are processed are implemented in various exemplary embodiments.

As data packets enter an intrusion prevention system or deep packet inspection device, each packet is inspected according to one or more of the embodiments described herein. In various exemplary embodiments, all data packets are inspected, regardless of the type of data packet. Thus, the subject matter described herein is not limited simply to TCP or UDP protocols.

After deriving the hash value of each vulnerability in step 106, the method 100 proceeds to step 108 where the hash values are stored in a table. Thus, in various exemplary embodiments, known attack fingerprints are stored in a system storage region. In this manner, various exemplary embodiments build a run time hash table.

It should also be apparent that the hash table is regularly updated as new vulnerabilities are identified. In various exemplary embodiments, the index table created in step 108 is restricted to a predetermined number of entries. Thus, in various exemplary embodiments, the processing time for processing steps that involve the value stored in the index table is reduced.

In various exemplary embodiments, step 108 is omitted. Such embodiments are believed to be preferable when the quantity of data being analyzed is small. However, when the quantity of data being analyzed is large, it is believed to be preferable to include an index table to store hash values in real time. Such embodiments are believed to offer faster processing time for larger index table sizes. In other words such embodiments are believed to offer faster processing time when the size of the vulnerability database created in step 104 becomes quite large.

The exemplary method 100 then proceeds to step 110 where data is transferred across the network. Next, in step 112, a field of interest is identified in each data packet transferred across the network in step 110. This field of interest corresponds to the field of interest of the vulnerabilities stored in the vulnerability database, as discussed above.

Following step 112, the method 100 proceeds to step 114 where a hash value is calculated for the field of interest identified in step 112. The method 100 then proceeds to step 116 where a determination is made whether the hash value calculated in step 114 has a match to any hash value stored in the hash table in step 108.

The method 100 then proceeds to step 118 where a conclusion is formed regarding the evaluation performed in step 116. If a conclusion is reached in step 118 that no match exists between the hash value derived in step 114 and any hash value stored in the hash table in step 108, the method 100 proceeds to step 120 where the data packet from the data stream received in step 110 is forwarded through the network.

If a conclusion is reached in step 118 that a match does exist between the hash value derived in step 114 and one or more hash values stored in the hash table in step 108, then the method 100 proceeds to step 122. In step 122, the more detailed comparison is made regarding the actual contents of the packet from the data stream received in step 110 and the data packet in the vulnerability database from step 104 that resulted in a matching hash value.

The method 100 then proceeds to step 124 where a conclusion is formed regarding the comparison of the actual data packet contents from step 122. If the conclusion reached in step 124 that there is not a match between the actual contents of the data packet received in the data stream in step 110 and the data packet listed in the vulnerability database from step 104 then the method 100 proceeds to step 120 where the data packet is forwarded through the network.

If a conclusion is formed in step 124 that there is a match between the contents of the data packet received in the data stream in step 110 and the data packet entered in the vulnerability database in step 104, then the method 100 proceeds to step 126 where the network is alerted to apply any filtering policy or other treatment pertinent to data packets believed to be malicious or otherwise creating a vulnerability in the system. Thus, in various exemplary embodiments, an IPS or DPI device applies policies to the data packet in question for containment or elimination of the data packet. Following steps 120 and 126, the method 100 proceeds to step 128 where the method 100 ends.

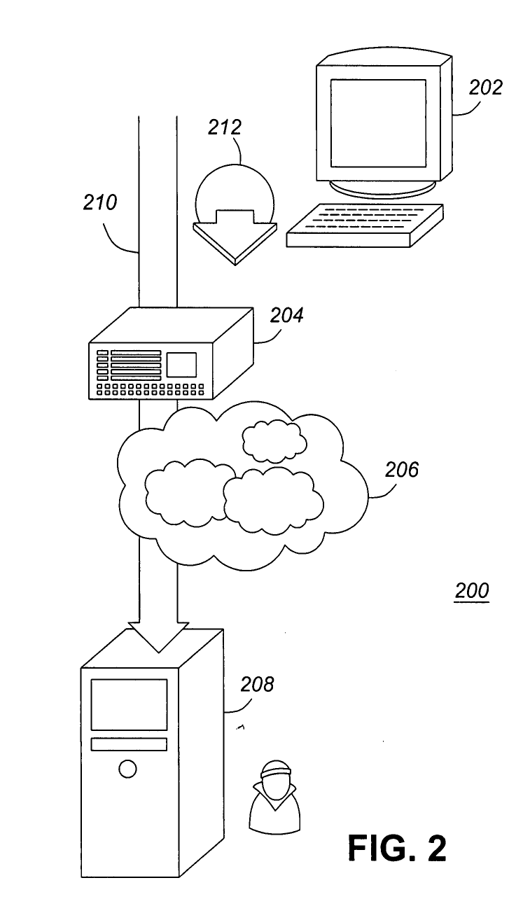

FIG. 2 is a schematic diagram of an exemplary embodiment of a system 200 for data content matching. The system 200 includes a client workspace in 202, and IPS/IDS 204, a network 206, a website server 208 and an application stream 210. The client workspace in 202 sends a web request 212 through the application stream 210. The application stream 210 passes the web request 212 to the IPS/IDS 204.

The IPS/IDS 204 represents the physical location where a hash value is derived. In the example of the web request 212 for content of an Internet website, the hash value derived by the IPS/IDS 204 is the hash value of the uniform resource locator (URL) for the Internet website.

It is also at the location of the IPS/IDS 204 where the other steps of the exemplary method 100 are performed. When the packet is forwarded in step 120, that information from the application stream 210 is then passed to the network 206 and subsequently to the website server 208.

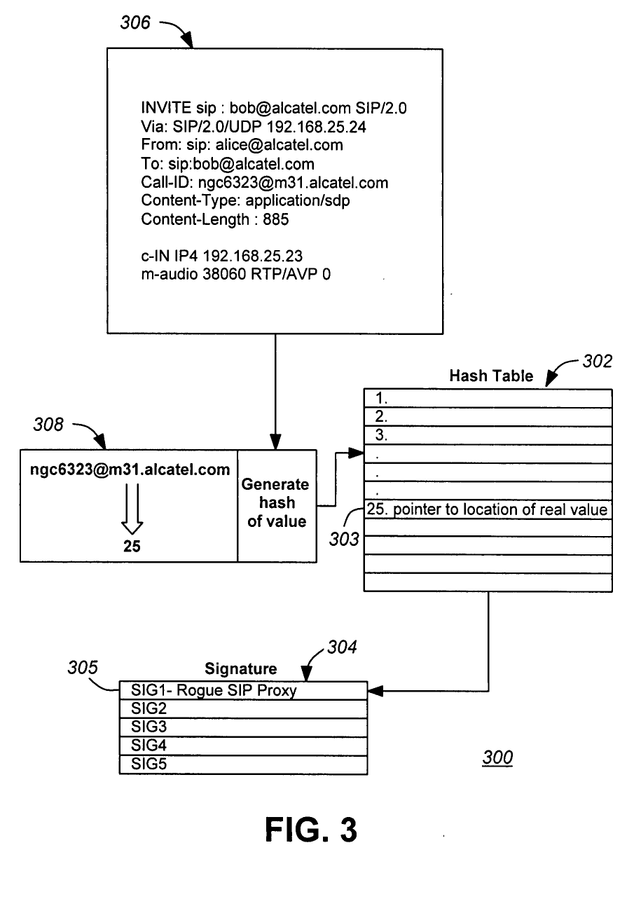

FIG. 3 is a schematic diagram of an embodiment of data 300 as used in a system and method for data content matching. The data 300 includes a hash table 302, a signature table 304, a data block 306 and a hash generator 308.

The data block 306 corresponds to an exemplary SIP INVITE packet. In the example using data 300, the field of interest is identified to be the information contained in the fifth line of the data block 306. This field of interest is identified as a call-ID. This is the call-ID field of the INVITE session.

This information is passed to the hash generator 308 where a hash value of 25 is generated from that information. The generated hash value of 25 is then compared to the hash values stored in the hash table 302. In this example, the hash value 25 appears in the hash table 302 at hash location 303.

Hash location 303 includes a pointer to the location of a real value associated with hash value 25. In other words, the hash value is used as an index to the signature table 304 to check for a match.

After performing the look up of the hash value 25, the packet is forwarded if no match is found. However, if a hash match is located, as in this example, a further evaluation is made whether there is a match in the signature table of a signature related to the alert. If a signature match is also confirmed, in other words, if the signature of data block 306 corresponds to the signature stored in signature block 304 for the signature of a rogue SIP proxy, then the filter policy is applied as in step 126.

In this example, the signature table 304 includes a real value at line 305 pointed to by the pointer at hash location 303. The pointer location at line 305 is indexed in the signature table 304 as SIG1. The index SIG1 is identified as being a rogue SIP proxy. Thus, based on this identification, a system policy regarding treatment of rogue SIP proxies is applied to the data block 306. Based on an application of this system policy, data block 306 may be contained or eliminated in various exemplary embodiments.

Advantages of the subject matter described above include the following. Little overhead is placed on packets to keep latency and packet loss to a minimum. A detection can be quickly made whether the target field has a value of interest. Hash collisions are eliminated by a secondary confirmation process which insures that false positive hash collisions are eliminated. This secondary confirmation process corresponds to steps 122 and 124 in exemplary method 100.

The subject matter described herein can be used in connection with any known, or later developed, hashing mechanism. Further, the subject matter described herein is not restricted to just one hashing mechanism. Also, the subject matter described herein is not restricted to any one specific IP protocol and service. Rather, the subject matter described herein relates to a target field.

Based on the foregoing, the subject matter described herein can be used by security vendors to enable faster processing of content based security attacks. It should be apparent that other embodiments and applications of the subject matter described herein exist.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A method of matching data content, comprising:
identifying items of data that would be potentially harmful if transferred through a network;
creating a list containing the identified items of potentially harmful data;
deriving a hash value for each item of data on the list;
receiving a data stream containing data packets;
calculating a hash value for each data packet in the data stream;
evaluating whether any of the hash values calculated for the data packets in the data stream match any of the hash values derived for each item of data on the list;
discovering a hash value match between one of the data packets in the data stream and one of the items of data on the list;
comparing the actual contents of the one data packet in the data stream to the actual contents of the one item of data on the list;
confirming a match between the actual contents of the one data packet in the data stream and the one item of data on the list; and
applying a filter policy that restricts a further transfer of the one data packet through the network.

2. The method of matching data content according to claim 1, further comprising storing the hash values to a table.

3. The method of matching data content according to claim 1, further comprising:
selecting a predetermined maximum size of a hash value table;
creating the hash value table with the predetermined maximum size;
determining that the hash value table is not full; and
storing the hash values to the hash value table until the hash value table is full.

4. The method of matching data content according to claim 1, wherein the method is performed at a line rate of the network.

5. The method of matching data content according to claim 1, wherein data is transferred through the network at a data transfer rate above ten gigabytes per second, and the steps of calculating and evaluating are performed on every packet of data transferred through the network without reducing the rate at which data is transferred through the network.

6. The method of matching data content according to claim 1, wherein data is transferred through the network at a data transfer rate above ten gigabytes per second, and the steps of calculating and evaluating are performed on every packet of data transferred through the network without introducing a latency in the transfer of data through the network.

7. The method of matching data content according to claim 1, wherein the network is selected from the list consisting of a carrier network and an enterprise network.

8. A method of matching data content, comprising:
identifying items of data that would be potentially harmful if transferred through a network;
creating a list containing the identified items of potentially harmful data;
identifying a field of interest for each item of data on the list;
deriving a hash value for each field of interest identified for each item of data on the list;
receiving a data stream containing data packets;
identifying a field of interest for each data packet in the data stream, wherein the field of interest identified for each data packet in the data stream corresponds to the field of interest identified for each item of data on the list;
calculating a hash value for each field of interest identified for each data packet in the data stream;
evaluating whether any of the hash values calculated for the fields of interest identified for each data packet in the data stream matches any of the hash values derived for each field of interest identified for each item of data on the list;
discovering a hash value match between one of the fields of interest for one of the data packets in the data stream and one of the fields of interest for one of the items of data on the list;
comparing the actual contents of the one data packet in the data stream to the actual contents of the one item of data on the list;
confirming a match between the actual contents of the one data packet in the data stream and the one item of data on the list; and
applying a filter policy that restricts a further transfer of the one data packet through the network.

9. The method of matching data content according to claim 8, further comprising storing the hash values to a table.

10. The method of matching data content according to claim 8, further comprising:
selecting a predetermined maximum size of a hash value table;
creating the hash value table with the predetermined maximum size;
determining that the hash value table is not full; and
storing the hash values to the hash value table until the hash value table is full.

11. The method of matching data content according to claim 8, wherein the method is performed at a line rate of the network.

12. The method of matching data content according to claim 8, wherein data is transferred through the network at a data transfer rate above ten gigabytes per second, and the steps of calculating and evaluating are performed on every packet of data transferred through the network without reducing the rate at which data is transferred through the network.

13. The method of matching data content according to claim 8, wherein data is transferred through the network at a data transfer rate above ten gigabytes per second, and the steps of calculating and evaluating are performed on every packet of data transferred through the network without introducing a latency in the transfer of data through the network.

14. The method of matching data content according to claim 8, wherein the network is selected from the list consisting of a carrier network and an enterprise network.

15. The method of matching data content according to claim 8, wherein the one of the fields of interest for one of the data packets in the data stream is a uniform resource locator identifying an Internet location, and the one of the fields of interest for one of the items of data on the list is a uniform resource locator identifying an Internet location.

16. A device that matches data content, comprising:
an identifying mechanism that identifies items of data that would be potentially harmful if transferred through a network;
a creator that creates a list containing identified items of potentially harmful data;
a deriving mechanism that derives a hash value for each item of data on the list;
a receiver that receives a data stream containing data packets;
a calculator that calculates a hash value for each data packet in the data stream;
an evaluator that evaluates whether any of the hash values calculated for the data packets in the data stream match any of the hash values derived for each item of data on the list;
a discovery mechanism that discovers a hash value match between one of the data packets in the data stream and one of the items of data on the list;
a comparer that compares the actual contents of the one data packet in the data stream to the actual contents of the one item of data on the list;
a matcher that confirms a match between the actual contents of the one data packet in the data stream and the one item of data on the list; and
a filter that applies a filter policy restricting a further transfer of the one data packet through the network.

17. A device that matches data content, comprising:
a first identifier that identifies items of data that would be potentially harmful if transferred through a network;
a creator that creates a list containing the identified items of potentially harmful data;
a second identifier that identifies a field of interest for each item of data on the list;
a deriver that derives a hash value for each field of interest identified for each item of data on the list;
a receiver that receives a data stream containing data packets;
a third identifier that identifies a field of interest for each data packet in the data stream, wherein the field of interest identified for each data packet in the data stream corresponds to the field of interest identified for each item of data on the list;
a calculator that calculates a hash value for each field of interest identified for each data packet in the data stream;
an evaluator that evaluates whether any of the hash values calculated for the fields of interest identified for each data packet in the data stream matches any of the hash values derived for each field of interest identified for each item of data on the list;
a discoverer that discovers a hash value match between one of the fields of interest for one of the data packets in the data stream and one of the fields of interest for one of the items of data on the list;
a comparer that compares the actual contents of the one data packet in the data stream to the actual contents of the one item of data on the list;
a confirmer that confirms a match between the actual contents of the one data packet in the data stream and the one item of data on the list; and
an applier that applies a filter policy restricting a further transfer of the one data packet through the network.
